(19) United States
(12) Patent Application Publication
(10) Pub. No.: US 2018/0359155 A1
(43) Pub. Date: Dec. 13, 2018

(54) ACTIVE TEMPERATURE MANAGEMENT OF NETWORK RESOURCES

(71) Applicant: PHILIPS LIGHTING HOLDING B.V., EINDHOVEN (NL)

(72) Inventors: BJORN CHRISTIAAN WOUTER KAAG, HEERLEN (NL); RALPH THEODORUS HUBERTUS MAESSEN, ROERMOND (NL)

(73) Assignee: PHILIPS LIGHTING HOLDING B.V., EINDHOVEN (NL)

(21) Appl. No.: 16/060,086

(22) PCT Filed: Dec. 5, 2016
(86) PCT No.: PCT/EP2016/079747

§ 371 Date: Jun. 7, 2018

(30) Foreign Application Priority Data
Dec. 11, 2015 (EP) 15199588.3

(51) Int. Cl. H04L 12/24; H04L 12/10; H04L 12/721; H04L 12/26

(52) U.S. Cl. CPC H04L 41/147; H04L 43/16; H04L 45/70; H04L 12/10

(57) ABSTRACT

The invention relates to an apparatus and method for controlling the workload of a plurality of intermediate forwarding devices (102) in an application control network. For each intermediate forwarding device operated in a predetermined configuration an individual temperature characteristic is determined and a maximum workload for each data forwarding unit based on the temperature characteristics and the respective predefined configuration is extrapolated. Information on a plurality of communication path configurations through the application control network (300) to one or more application control components (301-305) required by an application scene defined in an application plan (202) is used and a particular communication path configuration from the plurality of communication path configurations is selected that keeps the workload of each intermediate forwarding device below the maximum workload. The selected communication path configuration is programmed into the intermediate forwarding devices for the duration of an application scene.

### FIELD OF THE INVENTION

The invention relates to managing network resources within an application control network. In particular, the invention relates to an apparatus and method for active temperature management within an underlying network of an application control system.

### BACKGROUND OF THE INVENTION

When operating electronics at high temperature conditions, non optimal operation or even unstable operation is often to be observed. In addition, the life cycle of such electronics will be reduced. Although electronics can be designed to operate in hot environments for long times, this generally involves derating which creates higher cost. One method to observe from the outside if some electrical components operate under hot conditions is to use an external thermometer or use FLIR (Forward Looking InfraRed) cameras.

Alternative to measuring temperature with external equipment, a thermometer may be built into a managed application component that is remotely read out at certain intervals. An example is the SNMP management protocol where Management Information Base definitions, as described in RFC-1213 published by the SNMP Working group in 1991, can be used to define objects to be monitored, such as e.g. a temperature value. Many present network devices do not implement a management interface such as SNMP, because interfaces are deemed complex and unsecure.

In modern application control networks wired or wireless communication networks are used to connect application control components, such as sensors and/or actuators, with one or more controllers, e.g. a central control unit or distributed control units. For instance, a sensor detects a signal, transmits the signal via a digital medium, that may be wired or wireless, to a controller that is configured to decide upon an action to be taken and transmits a corresponding digital message over the transmission medium to an actuator, that switches an electrical load. The communication network connecting the sensors and actuator has thus become an essential part to the functionality and safety of an application control network. FIG. 1 shows an application control network 300 which comprises one or more application control components 301 such as a sensor to detect a signal and/or an actuator to switch an electrical load. The application control component 301 may be powered by a wired communication link, e.g. Power over Ethernet (PoE), or alternatively by an optional energy source or storage 330. The application control component 301 may be connected via wire or wirelessly to a border network component 101, which is part of communication network 100. The border network component 101 is connected to a network management system, such as a Software Defined Network (SDN) system 230 via a network path 180. The network path 180 is capable of passing and forwarding data according to predefined rules (i.e. communication path definitions) programmed by the SDN system 230. The Software Defined Application (SDA) system 203 may access an application plan 204, which stipulates which sensors and actors are required to engage in an application scene, e.g. switching on/off the lights and/or presence detectors in a room of a building for a particular time period, e.g. day/night. Wherein the SDN system 230 may determine all possible communication paths through the network connecting the respective application control components, the SDA system 203 may determine a “best” path based on the application plan (taking into account time, frequency and duration of respective application scenes) as well as other constraints such as overall energy consumption, et cetera. The SDA system 203 may combine all required paths for all components that are part of one or more application scenes and identify components which are not required at a particular time slot. The SDA system 203 may thus generate the information that is required to switch off components in the application control network 300, including intermediate network components in the communication network 100 or a (ny subset of) sensor(s) or actuator(s) and assists the SDN system 230 to program the correct communication path definitions (filters with correct duration and addressing) and/or power change commands (on/off/idle/other power status level).

The network path in between 180 as shown in FIG. 1 may implement a number of hops via intermediate forwarding devices. There are different types of intermediate forwarding devices:
Data forwarding devices, such as—but not limited to—data switches, that support communication of data. This type is typically used in the communication “backbone” network where no electrical loads need to be supported.
Data forwarding devices supporting communication of data and power delivery to an attached load. This type is typically used on locations where electrical loads require power and may not have an external power supply.
Power routers primarily supporting power delivery but also capable of forwarding data, wherein the power throughput of the power routers is higher than for common data forwarding devices such as data switches and or data routers.

Hence, proper operation of the intermediate forwarding devices within the network is crucial.

Nominally, each intermediate forwarding device has a temperature range in which it may safely be operated. However, the conditions for correct operation of an intermediate forwarding device in its thermal comfort zone cannot be assured under all circumstances, as indicated by the following examples. When the intermediate forwarding devices are installed in closed cabinets without sufficient cooling, the intermediate forwarding devices may overheat. Other examples of confined spaces are installations behind insulating material, without air circulation, or with otherwise limited thermal dissipation. During the construction of a network covered area (of a building), the building process may produce dirt and dust. Typically dust and dirt can enter the intermediate forwarding device and cause (integrated) fans to run slower or stop or otherwise degrade thermal dissipation capacity by for example blocking ventilation holes. As mitigation, the intermediate forwarding equipment may be covered in plastic directly after installation and prior to commissioning. Once the construction process is finished the covering material is removed. But if the removal of the covering material is forgotten, the intermediate forwarding device may overheat after it is powered up. Over time cooling fans in the intermediate forwarding devices may collect dust on their blades and move slower. This could reduce the cooling capacity at a later time, introducing unplanned problems later that may result in expensive maintenance measures. Sometimes intermediate forwarding devices are installed at locations where they cannot be inspected, for example behind wall or ceiling panels or confined spaces. Removing panels is costly or sometimes not possible at all. Some confined spaces may be difficult to open and/or enter.

One example of the new type of intermediate forwarding devices that can provide power via its ports to a connected end node is Power over Ethernet equipment, as described in “IEEE Standard for Ethernet”, IEEE Std 802.3-2012, clause 33. Future types of PoE equipment may support high electrical loads, up to 90 We as disclosed in the amendment document to the Ethernet Standard P802.3bt. Such electrical loads in itself may consume more power when they get older and increase the amount of power they draw from the intermediate forwarding device. This may influence the thermal behaviour of the intermediate forwarding device negatively due to losses in its Power Supply Unit (i.e. PSU). Future impacts on the thermal behaviour may not be known or not have been understood or expected at the moment of installation.

Hence, an intermediate forwarding device may overheat due to a plurality of reasons, such as installation problems, changing working conditions and high electrical loads, and if so, can significantly degrade the capabilities of the application control network.

### SUMMARY OF THE INVENTION

It is thus an object of the present invention to provide an apparatus and method to improve the stability of proper operation of intermediate forwarding devices within an application control network.

The objective is achieved by a management unit, method and computer program for managing an application control network according to the independent claims. Preferred embodiments are defined by the dependent claims.

In an aspect of the present invention there is provided a management unit for controlling the workload of a plurality of intermediate forwarding devices capable of forwarding data or capable of forwarding data and power in an application control network, wherein each intermediate forwarding device comprises one or more ports each connectable to a respective application control component and/or to a further intermediate forwarding device. The management unit comprises a monitoring unit for determining an individual temperature characteristic of each intermediate forwarding device operated in a predetermined configuration, a prediction unit for extrapolating a maximum workload for each intermediate forwarding device based on the temperature characteristic and the respective predetermined configuration. The management unit further comprises a control unit for receiving information on a plurality of communication path configurations along the intermediate forwarding devices through the application control network to one or more application control components required by an application scene determined in an application plan. The control unit is configured to select a particular communication path configuration from the plurality of communication path configurations that keeps the workload of each intermediate forwarding device below the maximum workload and to assist in applying the communication path configuration to the intermediate forwarding devices for the duration of the application scene.

The management unit can optimize the control of the network capabilities and thus extend the life cycle of the intermediate forwarding devices by actively managing the thermal operation of the intermediate forwarding devices. Operation in temperature regimes which are sub-optimal and thus may damage the respective electronics of the intermediate forwarding device can be avoided. The management unit monitors the individual progression of the temperature curve of an intermediate forwarding device over time, for instance via a management protocol (e.g. SNMP), with a proprietary extension to remotely inspect temperature at certain intervals (for example the “OID” of said SNMP protocol). The intermediate forwarding device may be any device capable of forwarding data or data and power, such as a data switch with or without the capability to support PoE, a data router or a power router supporting a significantly higher power throughput than common data switches but also provide the capability of forwarding data. The different communication path configurations define chains of intermediate forwarding devices along the path. The total power required by an intermediate forwarding device connected with an application control component as receiving end node may be provided via different power routing paths (e.g. different chains of intermediate forwarding devices) to distribute the power throughput for the intermediate forwarding devices engaged in a respective path configuration. Thus, wherein data addressed to an end node is usually forwarded via one or more communication paths (depending on the desired level of redundancy) as a whole, the total amount of energy to be provided to an intermediate forwarding device connected with one or more application control components, may be split into two or more portions to be routed along different paths to distribute the workload to the intermediate forwarding devices along the respective paths. That way a flexible thermal management of the intermediate forwarding devices is enabled by distributing the workload within the application control system while optimizing the balance in accordance with predetermined preferences. Based on the additional knowledge provided by the application scenes reflecting the scheduled operation of the application control system to control the loads, the system may a.) avoid overheating and b.) align load levels over a plurality of intermediate forwarding devices engaged in an application scene. Thereby the management unit may extend the life of intermediate forwarding devices and preserves the capabilities of the application control network. The management unit may keep track of warm or hot intermediate forwarding devices, use the corresponding data to predict end temperatures so as to decide on a mitigation strategy to extend the life of the intermediate forwarding device.

In an embodiment of the present invention at least one of the application control components is powered over Ethernet via a port of one of the intermediate forwarding devices.

In an embodiment of the present invention the monitoring unit receives measurement and operation data samples from each intermediate forwarding device, wherein the measurement and operation data samples are taken over a predetermined time interval either during commissioning and/or during normal operation of the application control network, and wherein the operation data comprises a number of ports in use and the measurement data comprises an end temperature and an accumulated power provided over all ports of the intermediate forwarding device. In many situations the loads connected to an intermediate forwarding device will be identical over a long period of time, e.g. in a lighting application, such that their static power consumption behaviour is reproducible. In such cases it may be sufficient to determine the number of ports and the overall power consumption as measurement and operation data to determine the individual temperature characteristic of an intermediate forwarding device. While taking the measurement and operation data once during commissioning provides a good starting point for determining the individual temperature characteristic, it can be advantageous to sample the data on a regular basis during operation to account for environmental changes, dust accumulation, et cetera.

In an embodiment of the present invention, if the control unit determines that there is no suitable communication path configuration that keeps the respective workload of the plurality of intermediate forwarding devices below the respective maximum workloads, the control unit is configured to

(i) decrease a power output to one or more ports of a selected intermediate forwarding device, and/or

(ii) switch off one or more ports of a selected intermediate forwarding device; and/or

(iii) switch off a selected intermediate forwarding device; and/or

(iv) schedule a power output to a first group of one or more application control components associated with a selected intermediate forwarding device to start when a power output to a second group of one or more application control components associated with the selected intermediate forwarding device has finished wherein a first application scene associated with the first group of one or more application control components and a second application scene associated with the second group of one or more application control components overlap in time.

The management unit can use accumulated knowledge to predict critical situations in which the workload on an intermediate forwarding device is too large and the intermediate forwarding device may be in danger of overheating and thereby be damaged. The management unit may adapt certain requirements set out in the respective application scenes and determine what capabilities can remain operational or are not available for a certain time. The management unit can optimize the application plan by adapting the scenarios and/or requirements set out therein and advise on improvements. Possible adaptation measures are:
Decreasing the power level of a port to the attached electrical load, so as to keep the temperature within an acceptable range. An application scene may define acceptable minimum power levels, which still allow the application control network to function appropriately. An example is an electrical load that is required at a specific moment, but does not need to be run at 100%, such as a dimmed light.
Switching off port(s) attached to electrical load(s). Based on the application plan and the network topology selected ports may be switched off without losing essential interconnection within the application control network. Switching off a port may also be used to effectively switch off entire data paths, which may help to keep the temperature of a selected intermediate forwarding device within an acceptable range.
Switching off the entire intermediate forwarding device. It may be decided to switch off an entire intermediate forwarding device when data and power may be forwarded via alternative paths though the network or when it is determined that a limited degradation of the capabilities of the application control network is acceptable in terms of system performance for a given duration.
Scheduling the power level of the port attached to the electrical load. If two application control components are stipulated by an application plan at overlapping times, it may be determined, if the required action caused by one of the application control components is time critical or can be delayed to keep temperature in an acceptable range. An example is an electrical motor that can run now or later, but when it runs needs its required amount of power.

In an embodiment of the present invention, if the control unit determines that there is no suitable communication path configuration that keeps the respective workloads of the plurality of forwarding devices below the respective maximum workloads, the control unit is configured to provide a warning notification.

In an embodiment of the present invention the control unit is configured to select the communication paths belonging to an application control scene that provides a predetermined level of redundancy, a predetermined level of availability, a predetermined level of service of quality or a combination thereof.

In an embodiment of the present invention the application scene defines a minimal power level for one or more application control components and wherein, if it is determined that there is no suitable communication path configuration that keeps the respective workloads of the plurality of intermediate forwarding device below the respective maximum workloads, the control unit is configured to decrease a power output to one or more ports of a selected intermediate forwarding device attached to the one or more application control component down to the minimal power levels as set out in the application scene.

By setting minimal power levels the application control system may ensure that the power output provided at a respective port is sufficient to actually run the connected application component. For instance, in case of having a lighting application system, the application control components may be a lighting actuator. Below a minimal lighting level the illuminance provided by the light source of the lighting actuator will not serve any useful purpose. In such a case it would be more appropriate to switch off the light entirely.

In another aspect of the invention there is provided a method for controlling the workload of a plurality of intermediate forwarding devices capable of forwarding data or capable of forwarding data and power in an application control network, wherein each intermediate forwarding device comprises one or more ports each connectable to a respective application control component and/or a further intermediate forwarding device; the method comprising:

determining an individual temperature characteristic of each intermediate forwarding device operated in a predetermined configuration;

extrapolating a maximum workload for each intermediate forwarding unit based on the temperature characteristics and the respective predetermined configuration;

receiving information on a plurality of communication path configurations along the intermediate forwarding devices through the application control network to one or more application control components required by an application scene determined in an application plan, and

selecting a particular communication path configuration from the plurality of communication path configurations that keeps the workload of each intermediate forwarding device below the maximum workload and assisting in applying the communication path configuration to the intermediate forwarding devices for the duration of the application scene.

The one or more application control components may be powered over Ethernet via a port of one of the intermediate forwarding devices.

In an embodiment of the present invention determining an individual temperature characteristic of each intermediate forwarding device comprises receiving measurement and operation data samples from each intermediate forwarding device, wherein the measurement and operation data samples are taken over a predetermined time interval during commissioning and/or during normal operation of the application control network, and wherein the operation data comprises a number of ports in use and the measurement data comprises an end temperature and an accumulated power provided over all ports of the intermediate forwarding device.

In an embodiment of the present invention, if it is determined that there is no suitable communication path configuration that keeps the respective workload of the plurality of intermediate forwarding devices below the respective maximum workloads, the method comprises

(i) decreasing power output to one or more ports of a selected intermediate forwarding device, and/or

(ii) switching off one or more ports of a selected intermediate forwarding device; and/or

(iii) switching off a selected intermediate forwarding device; end/or

(iv) scheduling a power output to a first group of one or more application control components associated with a selected intermediate forwarding device to start when a power output to a second group of one or more application control components associated with the selected intermediate forwarding device has finished wherein a first application scene associated with the first group of one or more application control components and a second application scene associated with the second group of one or more application control components overlap in time.

In an embodiment of the present invention, if it is determined that there is no suitable communication path configuration that keeps the respective workloads of the plurality of intermediate forwarding device below the respective maximum workloads, the method comprises providing a warning notification.

In an embodiment of the present invention the method further comprises selecting a communication path configuration that provides a predetermined level of redundancy, a predetermined level of availability, a predetermined level of service of quality or a combination thereof.

In an embodiment of the present invention the application scene defines a minimal power level for one or more application control components and wherein, if it is determined that there is no suitable communication path configuration that keeps the respective workloads of the plurality of intermediate forwarding device below the respective maximum workloads, the method comprises decreasing a power output to one or more ports of a selected intermediate forwarding device attached to the one or more application control component down to the minimal power levels as set out in the application scene.

In another aspect of the invention there is provided a computer program for controlling the workload of a plurality of intermediate forwarding devices capable of forwarding data or capable of forwarding data and power in an application control network, the computer program being executable in a processing unit, the computer program comprising program code means for causing the processing unit to carry out a method as defined in claims 8-14, when the computer program is executed in the processing unit.

It shall be understood that the management unit of claim 1, the method of claim 8 and the computer program of claim 15 have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows a domain model of an application control network.

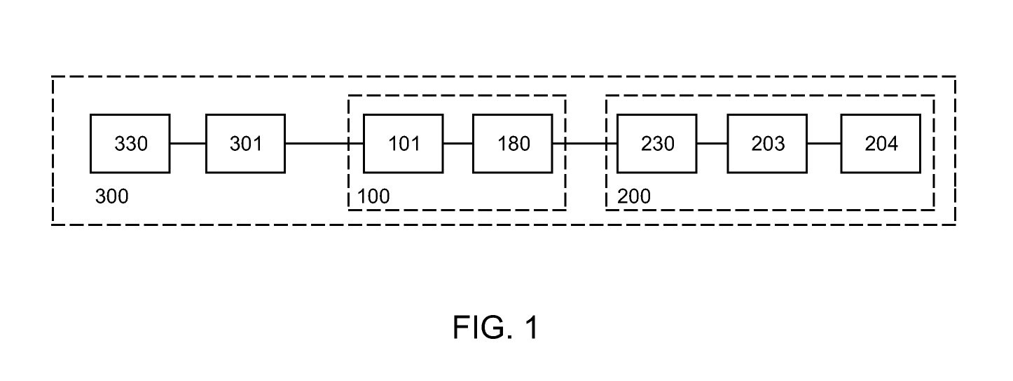

FIG. 2 shows a diagram of a lighting control network capable of active thermal management.

FIG. 3 shows an exemplary representation of information regarding an overheat situation.

FIG. 4 shows an exemplary thermal behaviour of an intermediate forwarding device.

FIG. 5 shows the thermal behaviour of an intermediate forwarding device for different numbers of used ports.

FIG. 6 shows the input values to the optimization algorithm

FIG. 7 shows a control line architecture to execute the load optimized application plan.

FIG. 8 shows an exemplary building environment with underlying network structure for exemplary use cases 1-3.

FIGS. 9a and b show communication path determination and selection for respective application scenes.

FIG. 10 shows an exemplary power plan X for use cases 1-3.

FIG. 11 shows the thermal responses of the data switches involved for power plan X.

FIG. 12 shows the thermal responses of the data switches for use case 1 scenario A.

FIG. 13 shows the thermal responses of the data switches for use case 1 scenario B.

FIG. 14 shows the thermal responses of the data switches for use case 1 scenario C.

FIG. 15 shows the thermal responses of the data switches for use case 2 switching off data ports.

FIG. 16 shows the thermal responses of the data switches for use case 3 switching off an entire data switches.

FIG. 17 shows an alternative exemplary building environment with underlying network structure with a heavy load according to use case 4.

FIG. 18 shows the thermal responses of the data switches for power plan Y.

FIG. 19 shows the thermal responses of the data switches for use case 4.

FIG. 20 shows the integration of an additional application and or networking control system into the software defined control system.

FIG. 21 shows a further embodiment of the present invention implementing power negotiation between power routers within a network topology.

### DETAILED DESCRIPTION OF EMBODIMENTS

Some embodiments are exemplary described in the context of lighting control applications as preferred embodiments. However, it is to be understood that the embodiments are not restricted to lighting control applications. The person skilled in the art will appreciate that the methods and devices may be exploited for any other control application requiring a similar system topology.

In the following a software defined application (SDA) system provides knowledge about application specific requirements and instructions as stipulated in an application plan comprising one or more application scenes. For instance, an example of an SDA system is a software defined lighting (SDL) system that defines a lighting plan comprising one or more lighting scenes. A lighting scene may for example define dependencies or interactions between application control components, e.g. which lamps are to be switched on if a particular sensor is triggered. The lighting scenes may be defined for specific timeslots, such a day or night, weekdays, weekends, and so on.

A network management system such as—but not limited to—a software defined networking (SDN) system provides knowledge about the respective network components present in a mesh network and may control configuration of forwarding tables and the like to determine one or more communication paths from source to end node through the network. However, the network management system does not know about application specific connections between certain network components. An application scene implemented with a particular communication path configuration is referred to herein as application control scene. The preferred embodiments may be described with reference to an SDN system as network management system. However, any other management system comprising similar functionality may be used.

Together the SDA system and the network management system constitute a software defined control (SDC) system which combines both layers (application and network). The SDC system maps the application/lighting components onto the network topology and thus has the knowledge to decide which components or component parts may be switched off without degrading the capability of the (lighting) control network to execute a (lighting) application.

The network management system, in particular the SDN, and SDA system may be implemented as program code means of a computer program, which can be executed on a processing unit, virtualized or real, such as but not limited to one or more computers having a central processing unit for accessing and executing the program code stored in internal or external memory. The processing unit may provide a user interface, e.g. a display and input means. The processing unit may be located on-site of the application control system or be located remotely from the application control system.

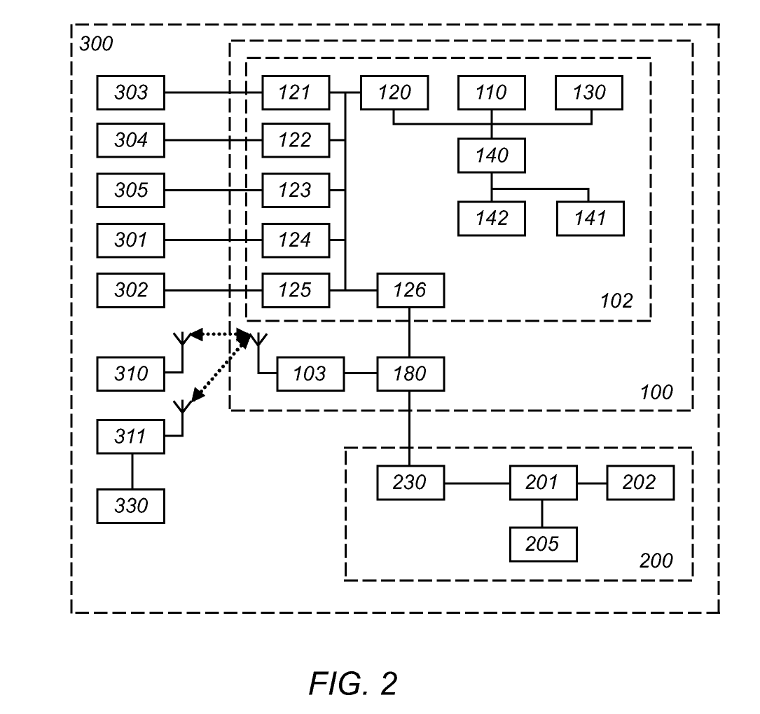

FIG. 2 shows a lighting control network 300 exploiting an exemplary embodiment of the present invention. The lighting control network 300 has a variety of sensors and actuators, such as for example but not limited to a lamp 303, a presence detector 304 with Passive InfraRed (i.e. PIR) sensor, a light switch sensor 305. Generally, any sensor 301 may be used interacting with any actuator 302 as required and as may be stipulated in the lighting plan 202. Based on lighting scene information from lighting plan 202 and communication path information obtained by the SDN system 231 as network management system, e.g. route discovery information on all available communication paths throughput the network, the SDL system 201 may select a suitable communication path configuration. By receiving further information from the intermediate forwarding devices the SDL system may extrapolate the resulting workload of the intermediate forwarding devices required by a communication path configuration. The SDL system 201 may take the resulting predicted end temperatures into account and can compute a load optimized application control plan 205. The resulting communication paths are then programmed by the SDN system 231 in accordance with the load optimized application control plan 205. That is, every intermediate forwarding device, e.g. a data switch or a router, receives an operation schedule defining to forward data and/or power for a specific end node to be forwarded along a specific path, e.g. to a further intermediate forwarding device or the end node itself. The operation schedule plan may define an operation status for an entire intermediate forwarding device, or may be set up to define the operation status of the individual ports of an intermediate forwarding device, separately. Each of the sensors and actuators 301-305 in FIG. 2 may be connected to a manageable data port 121 to 125 which may also be useable to provide power to a connected end node, such as Power over Ethernet (PoE). A manageable data/power port can switch or alter its power status to on/off or a power level in between. The manageable data/power ports 121 to 126 may be controlled by port management module 120. The port management module 120 can receive and process messages to switch a data/power port on/off/idle or to a power setting in between. The southbound module 110 will run a data protocol for interconnection with the SDN system 231 and/or the SDL system 201, so as to collect management information and receive operation instructions to execute the intermediate forwarding device in accordance with the load optimized application control plan 205. The forwarding module 130 implements rules how to forward data between ports. The modules 110, 120 and 130 may be implemented as software processes running on a micro-processor 140 using working memory 141 for execution and storage module 142 for saving computed results, storage of the firmware and optionally parts of the load optimized application control plan 205, e.g. an operation schedule for the respective intermediate forwarding device. In addition, the lighting control network 300 may deploy wireless sensors 311 and/or wireless actuators 310, which are connected via a wireless bridge 103 to the communication network 100. Data traffic between sensors, actuators and the SDL system 201 is transported via a network path in between 180, which is under control of the SDL system 201, selecting the “best” possible path to achieve optimal temperatures of all intermediate forwarding devices. Along the network path in between 180 there may be intermediate forwarding devices that can or cannot support managing temperature of the intermediate-forwarding device as a whole and the respective port(s) in particular. Furthermore, there may be power routers provided as intermediate forwarding devices along the data path whose power throughput is much higher than the power throughput of e.g. data switches.

To enable the SDL system to compute a load optimized application control plan, the SDL system first determines individual temperature characteristics for each intermediate forwarding device. The SDL system monitors data from the intermediate forwarding devices used in an application scene applying a particular data communication path configuration as input and derives an independent temperature rise factor per intermediate forwarding device. The SDL system uses knowledge from all the application scenes (how often are they used and what is the duration of usage) to build a map of the moments in time when particular components within the lighting system are powered. With input from each application scene the SDL system knows when ports on each and every intermediate forwarding device would be committed for a certain electrical load during a specific time period.

The SDL system will then use this information to compute and predict the end temperatures of the intermediate forwarding devices in the required application scene applying a particular data communication path configuration. Should the SDL system determine that a predicted end temperature exceeds a predetermined threshold, the SDL system may compile an optimal application control plan in time by adapting the power output required by one or more application scenes to control the temperature of the respective components. Possible adaptation measures are:
Dimming the power level of a port to the attached electrical load, so as to keep the temperature within an acceptable range. The SDL system may estimate whether or not dimming is actually acceptable. It inspects the plurality of sensors and/or actuators in the respective application scene, and may decide to align the behaviour against certain constraints. An example is a light that is required at a specific moment, but does not need to be run at 100%.
Scheduling the power level of the port attached to the electrical load. If scheduling is actually acceptable, is determined by the SDL system, which inspects if the required actions caused by the electrical load(s) are time critical or can be deferred in the future, so as to keep temperatures of the intermediate forwarding devices within an acceptable range. An example is an electrical motor that can run now or later, but when it runs, needs its required amount of power.
Switching off port(s) attached to the electrical load(s). Based on the application plan and the network topology discovered the SDL system has knowledge if switching off a port would result in lost interconnection, i.e. the network path between intermediate forwarding devices and if that loss is acceptable. The SDL system may also decide to switch off a (plurality of) ports to stop powering a part of the electrical load on the intermediate forwarding device, so as to keep the temperature of the intermediate forwarding device within an acceptable range.
Switching off the entire intermediate forwarding device. The SDL system may decide to switch off an entire intermediate forwarding device when it has the option to forward data and/or power via alternative paths or when it determines a limited degradation of the capabilities of the control network by switching off a intermediate forwarding device for certain duration is acceptable in terms of system performance.

The SDL system may determine important information with respect to the detection of overheating conditions of intermediate forwarding devices, at a present and/or a future instant, and the resultant possible optimizations as well as the expected loss of capabilities in the control network. It may be specifically useful to detect complex combinations of many application control scenes that will cause overheat conditions at some point in the future.

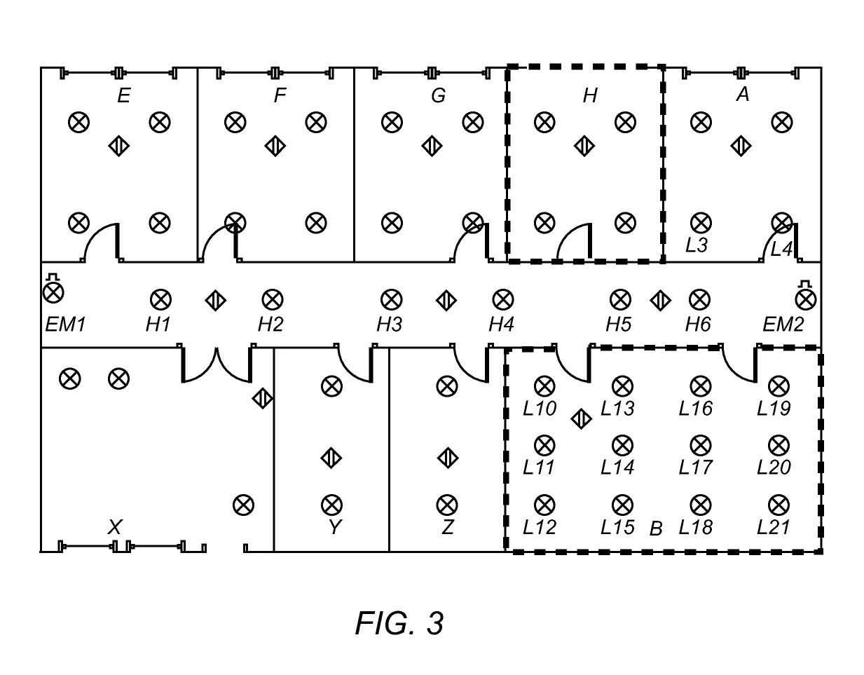

The prediction information generated by the SDL system may be provided to a user or system administrator using lists and tables, or a graphical representation. For example, the system may show the geographical location of an overheated or potentially overheating intermediate forwarding device on a building plan as indicated in FIG. 3 which highlights rooms H and B as being affected by a potential malfunction of an overheated intermediate forwarding device. Alternatively or in addition, the system may present the consequences that an overheated intermediate forwarding device would have on the application scenes in a building. For the subsequent selection of a further application scene (e.g. lighting configuration for an additional room) the SDL system will determine the respective status of the intermediate forwarding device(s) required by said application scenes. In general, the electrical loads in a single room can be served by one or more intermediate forwarding devices, with each intermediate forwarding device serving part of the electrical loads in that room. It is also possible that one intermediate forwarding device serves the electrical loads from more than one room. This is defined by application scenes and the network configuration. The system will determine if an intermediate forwarding device will overheat, can match the application scenes associated to the electrical loads attached to the intermediate forwarding device's ports, and can map the location of the application scenes on the graphical representation of the building, as is shown in FIG. 3. For example, the lights in room H shall be switched on and are served by the same intermediate forwarding device that is also partially serving lights in room B, in this case L10. If said intermediate forwarding device overheats and fails to operate, the system may notify that room H will not be served at all while room B is constrained. A warning may be generated and communicated via push notifications and alerts, e.g. via a generic user interface showing the affected room by highlighting the room in a building plan as indicated in FIG. 3. Managing power to optimize intermediate forwarding device end temperatures can help to extend the overall life cycle of the system components, by identifying single points of failure and selecting an effective mitigation strategy.

The observed input data may be provided for different granularities. In a first embodiment, the observation of input data may be limited to the temperature of the entire intermediate forwarding device for a given configuration. This approach is simplest, and the embodiment will be enabled to observe the end temperature of the specific intermediate forwarding device. However, this simple embodiment will not be able to distinguish different load conditions: it can only reuse the exact identical configuration that was measured before. In many situations the electrical loads connected to an intermediate forwarding device may be identical and their static power consumption is reproducible, e.g. data switches connected to application control devices, such as lights and sensors in a lighting application.

In a second, preferred embodiment the observation of input data covers more parameters to derive a temperature rise factor independent of the number of ports. The rise temperatures are related to the heat dissipation capacity of the respective intermediate forwarding device at the precise location where it was installed. The computation of an end temperature requires a predictor function. It is required to observe one heat-up cycle, but it can estimate the temperature rise factor independent of the number of ports committed and hence predict the end temperature for any scenario using any number of ports when the total accumulated power is known.

In the following the mechanism to understand the intermediate forwarding device heat-up behaviour independent of the number of ports will be described:

To compute a temperature rise factor of an intermediate forwarding device the SDL system collects data from the intermediate forwarding devices and computes a temperature rise factor independent from the number of ports on the intermediate forwarding device.

These input parameters are at least:

I. The number of ports of the device in use,
II. The end temperature over time in K samples at N intervals. A suitable amount of samples can be relatively low until a steady state is achieved. A suitable sampling frequency is for example every 10 or 15 minutes. Higher sampling rates may enhance the resolution, but also generate more network traffic. Hence, a smart protocol may collect many samples and transfer those in an optimized and/or compressed data structure.
III. Accumulated power over all ports, as delivered by the intermediate forwarding device.

It shall be clear that any number of ports on an intermediate forwarding device may be assigned to either only data communication or only power transfer or a combination of both. It shall also be clear that any power level can be chosen that is supported by both the powered device attached to the port and the intermediate forwarding device itself.

To describe the heating up behaviour of an intermediate forwarding device, e.g. a data switch or a power router, a first order approximation can be used:

mC_{P}dT/dt=P_{d}−1/Rₜₕ*(T_{IFD}−Tₛ) (1)

### Where

mCₚ=thermal capacity of the intermediate forwarding device [J/K].
P_{d}=dissipated thermal power in the intermediate forwarding device [W].
Rₜₕ=thermal resistance of the intermediate forwarding device to surrounding [K/W].
T_{IFD}=temperature of the intermediate forwarding device.
Tₛ=temperature of the surrounding.
The solution to formula F1 is shown in formula F2 below:

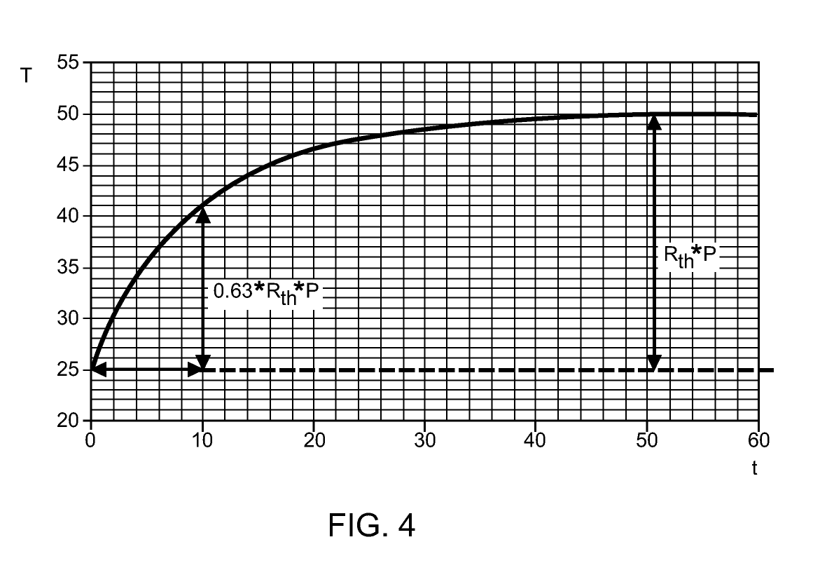

T_{IFD}=P_{d}*Rₜₕ*[1−exp(−t/τ)]+Tₛ (2)

where τ is the time constant of the intermediate forwarding device expressed as Rₜₕ*mCₚ. From the above equations follows that the thermal behaviour of the intermediate forwarding device is described by the (thermal) time constant t and the thermal resistance Rₜₕ (measure for the cooling of the device). For simplicity reasons, this combination is called the “rise factor” of the intermediate forwarding device. The rise factor (the time constant and thermal resistance) as defined in formula (1) is computed per intermediate forwarding device and is independent on the number of ports. The resultant end temperature of an intermediate forwarding device depends on the total dissipated power in an intermediate forwarding device.
By measuring a heating curve at a known dissipated load (i.e. the accumulated power of the entire intermediate forwarding device), the system can determine time constant t and thermal resistance Rₜₕ of the intermediate forwarding device. An exemplary function graph is shown in FIG. 4, with the input parameter values P_{d}=5 W, Rₜₕ=5 K/W, _{T}=600 s.
With the determined rise factor, the system can predict heating up curves and end temperature of an intermediate forwarding device for other load cases. Based on additional input parameters:
IV. The idle self-consumption of the intermediate forwarding device when no ports are used. If this parameter value cannot be measured online, it may be measured in a test setup or be estimated.
V. Indication per ports if said port is used for
a. data communication only (i.e. Tx/Rx channels but no power transfer) or
b. power transfer only (power transfer but no Tx/Rx channels) or
c. both data communications and power transfer (i.e. Tx/Rx channels and power transfer)
VI. Optionally, the amount of power consumed per port (is not required for the computation but may give additional information for management information purposes).

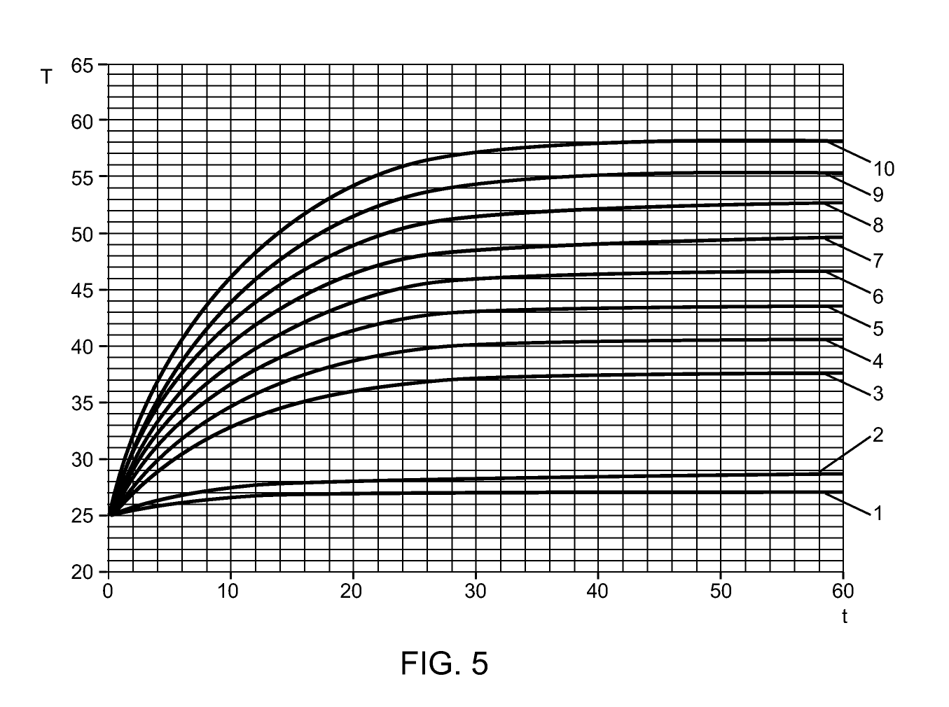

Table 1 shows an exemplary parameter list of an intermediate forwarding device with 10 ports for which the accumulated graph is depicted in FIG. 5. In this example each Tx/Rx channel consumes 500 m Wₑₗ. The 7 Wₑₗ load for PoE is assumed e.g. losses of 30% in (the PSU of) the intermediate forwarding device, resulting in 2 Wₜₕ losses.

| Port | Idle (Wₑₗ) | Tx/Rx | Load (Wₑₗ) | Heat (Wₜₕ) |
|---|---|---|---|---|
| 1 | 1W | No | 7 | 3 |
| 2 | 1W | Yes | N/A | 2 |
| 3 | 1W | Yes | 30 | 12 |
| 4 | 1W | Yes | 7 | 4 |
| 5 | 1W | Yes | 7 | 4 |
| 6 | 1W | Yes | 7 | 4 |
| 7 | 1W | Yes | 7 | 4 |
| 8 | 1W | Yes | 7 | 4 |
| 9 | 1W | Yes | 7 | 4 |
| 10 | 1W | Yes | 7 | 4 |

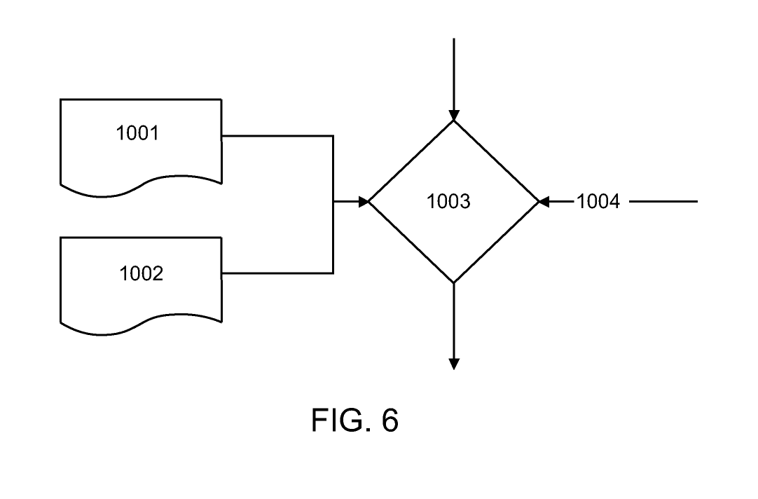

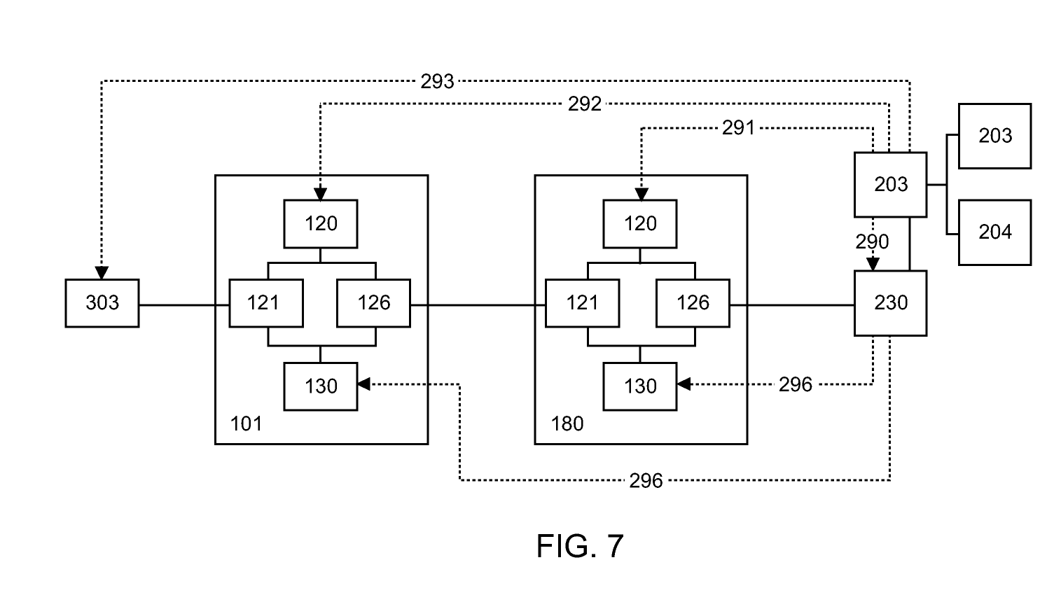

A best temperature advisor algorithm as depicted in FIG. 6 computes an optimized load configuration for all network components involved in one or more application scenes. The decision, if the requested load is (im)possible, may be augmented by additional considerations, such as for example (but not limited to):
A configurable granularity of the time that the load should be available.
A risk appetite (1004), which may be fixed or dynamically updated, for example the amount of redundancy or availability or quality of service required of an intermediate forwarding device compared to alternative paths, since an intermediate forwarding device does not only need to support loads but also enable data passing. The input parameters (1001) are the rise factors of the intermediate forwarding devices. The application scenes (1002) stipulate the committed electrical loads, their usage and duration, and may define minimum and maximum service levels for safe operation e.g. minimal light levels for lamps. The SDL system will use the temperature rise factor(s) to compute an end temperature in a specific scenario, which may be expressed as a graph or as a data structure such as a table. The system may use techniques to predict and optimize the end temperatures in certain time periods. Well-known methods, such as for example machine learning and/or (path) optimization and/or load optimization using e.g. graphs, may be used by the system to determine if an improvement is possible and if so, the system may give appropriate feedback or process the improvement into the load optimized application control plan 205 (1003). The plan is maintained by the SDL system. The SDL system can execute the load optimized application control plan by use of a control interface to manage the (loads on the) intermediate forwarding device remotely as depicted in FIG. 7. In order to switch on/off or otherwise change the status of the communication and/or power level of lighting control components 303 and/or intermediate forwarding devices within the application control network, the SDA system 203 has functional control lines to the relevant network components 101, 180, e.g. an intermediate forwarding devices, as shown in FIG. 7 and the table below:

| Control | Software Defined Application | |
|---|---|---|
| line | System 203 exerts control over . . . | By managing . . . |
| 290 | Data forwarding rules (i.e. filters) | SDN data path definitions |
| 291 | Data-port(s)/intermediate forward | Power state of port/device |
| | device(s) | |
| 292 | Data-port(s)/intermediate forward | Power state of port/device |
| | device(s) | |
| 293 | Sensor and/or actuator device | Power state of device |

It shall be understood that the control lines 290 to 293 can be separate protocols or bundled (wholly or partly) in respective network management protocols, such as SDN protocols. The lines 296 represent the interface between the network management system 230 (e.g. an SDN system) and the data forwarding module of devices 101 and 180 used to forward data over the interlink between the data ports 121, . . . 126 that are controlled by port management module 120 over control lines 291, 292, 293. Alternatively, the SDA system 203 may or may not (partially) download the portions of the load optimized application control plan into a specific intermediate forwarding device, e.g. as an operation schedule. The schedule may be processed by the management module even if the intermediate forwarding device is currently not connected to the SDA system.

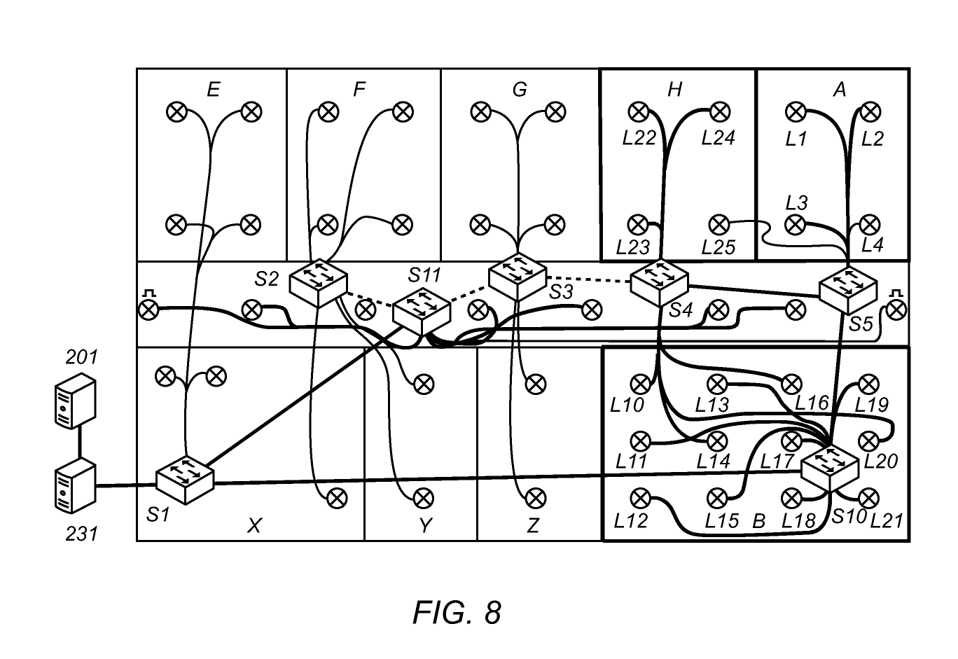

In the following a few examples shall illustrate how an SDA system can optimize load management and thus control the thermal behaviour of intermediate forwarding devices, such as the data switches in a lighting control network as a preferred embodiment. It shall be understood that this lighting control network may be integrated with different actuators of different building works. It shall also be understood that loads can have static or dynamic power requirements and that the examples do not exclude other types of sensors and/or actuators. For the example use cases discussed in the following a common building environment is defined as depicted in FIG. 8. It shall be clear that other building environments and network topologies can be used.

The examples require a definition of an example building plan with control network topology, and an example power plan that is used to compute optimization scenarios.

FIG. 8 shows a building plan of an arbitrary building with rooms A, B, E, F, G, H, X, Y, Z plus a hallway. Each room is provided with a plurality of lights, which are controlled according to a predefined application scene using a particular communication path configuration.

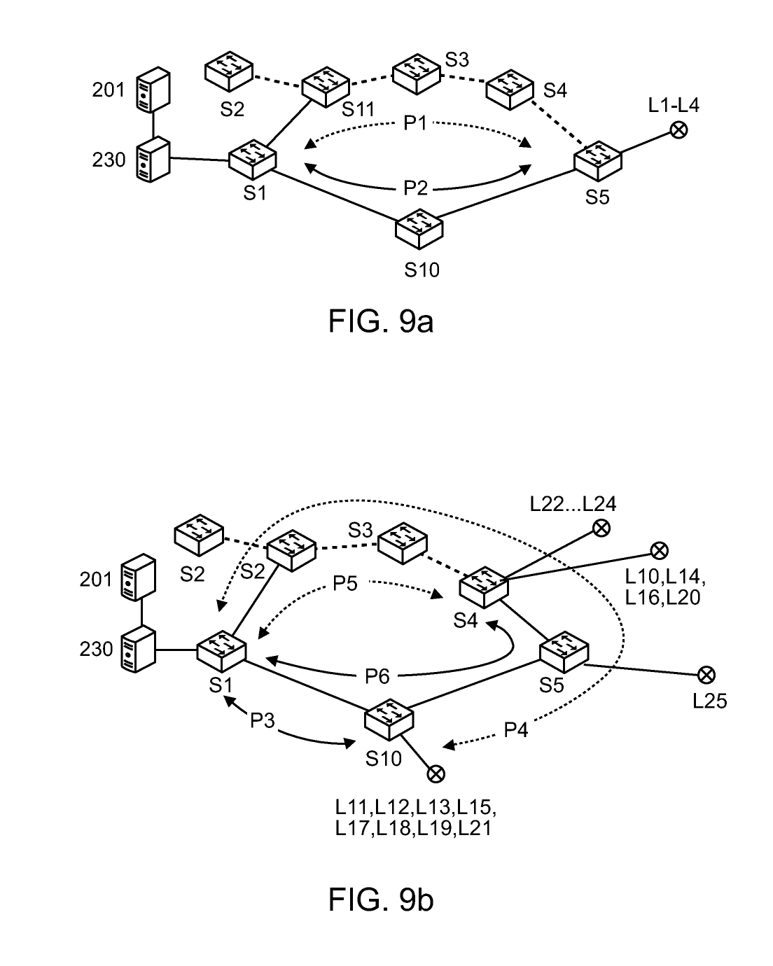

The lighting in the hallway shall be switched on 24/7: the lights are controlled through a path via data switch S1 and S11 as depicted in FIG. 8. The lights in the hallway are powered exclusively by data switch S11 in this example. The plurality of lights L1-L4 in room A shall be controlled by lighting scene 1, the lights L10-L21 in room B by lighting scene 2 and the lights L22-L25 in room H by lighting scene 3. In this example, the lights in a lighting scene may be connected to different data switches. In lighting scene 2 of room B, the lights are connected in an interleaved pattern to two different data switches S4 and S10 to preserve minimal lighting levels in case one data switch might fail. As shown in FIG. 9a lighting scene 1 is triggered to control lights L1-L4 in room A. The system determines two possible paths, path P1 via S1, S11, S3 and S4 to S5 and path P2 via S1, S10 and S5. In case no power constraints are set, the SDL system 201 may chose path 2 to keep energy consumption to a minimum and SDN controller 231 programs a corresponding communication path to data switches S1, S10 and S5. After a certain time, lighting scene 2 is triggered to control lights L10-L21 in room B. From the possible paths P3, P4, P5 and P6 shown in FIG. 9b the SDL system chooses path P6 to data switch S4 in accordance with predetermined optimisation parameters, e.g. energy consumption, redundancy level, et cetera. Sometime later, lighting scene 3 is triggered and the lights L22 . . . L25 in room H, which are connected to S4 and S5, shall be switched on. Since S4 and S5 were already switched on, path P6 may also be programmed to switch on the lights in room H via S4 and S5.

The SDL system may also implement a best path predictor capability to plan for mitigation strategies when a particular data switch would fail due to overheating. Some examples would be to analyse the network for alternatives to pass data and power via other paths and provide information about the capabilities of lighting scenes which would be lost and which capabilities would remain operational.

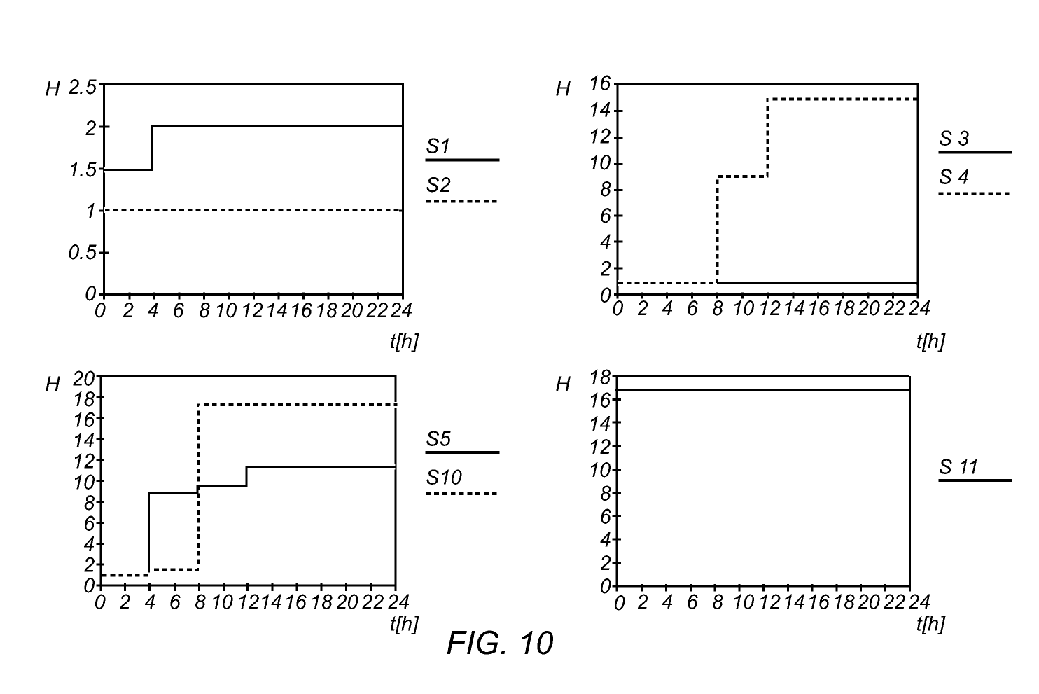

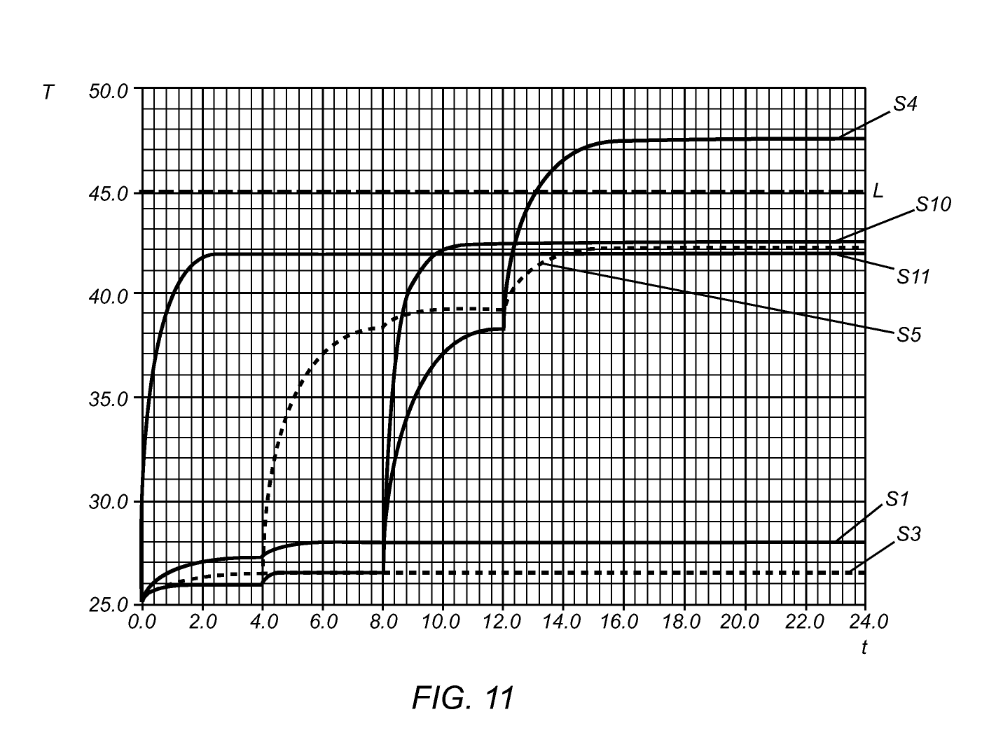

To further define the configurations for the example use cases, the building plan and network topology of FIG. 8 will execute a power plan X, as shown in FIG. 10. The power plan X assumes power dissipation in the data switches S1-S5, S10 and S11: standby=1 W, Tx=0.5 W, Rx=0.5 W. The power dissipation caused by the attached load is 2 W/load (typical lighting 700 lm=7 W, eff. Port 70%). Based on the input of the example power plan X of FIG. 10, as stipulated in lighting plan 201 of FIG. 2, the system can predict a temperature T as a function of time t for each data switch engaged in the application plan, which will saturate at an end temperature after a certain period of time as shown in example FIG. 11. The upper temperature limit L is an arbitrarily chosen limit at 45° Celsius. For the sake of simplicity the same upper temperature limit is chosen for all switches in the examples. It shall be clear that the switches may have different upper temperature limits depending on the type of switch, age, etc.

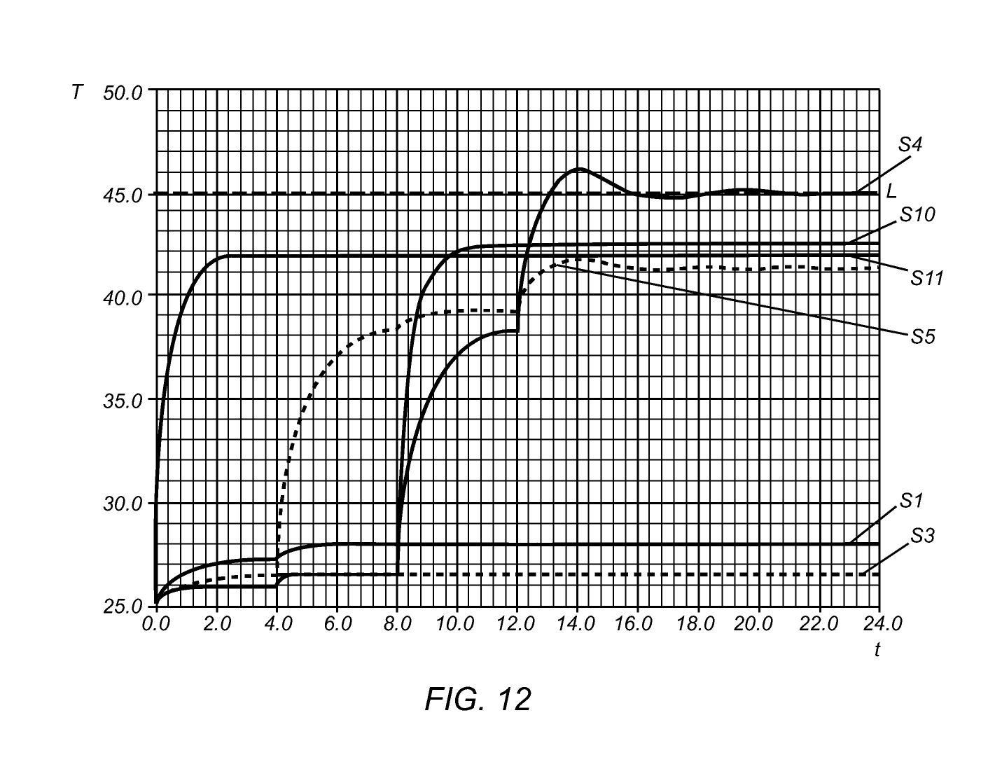

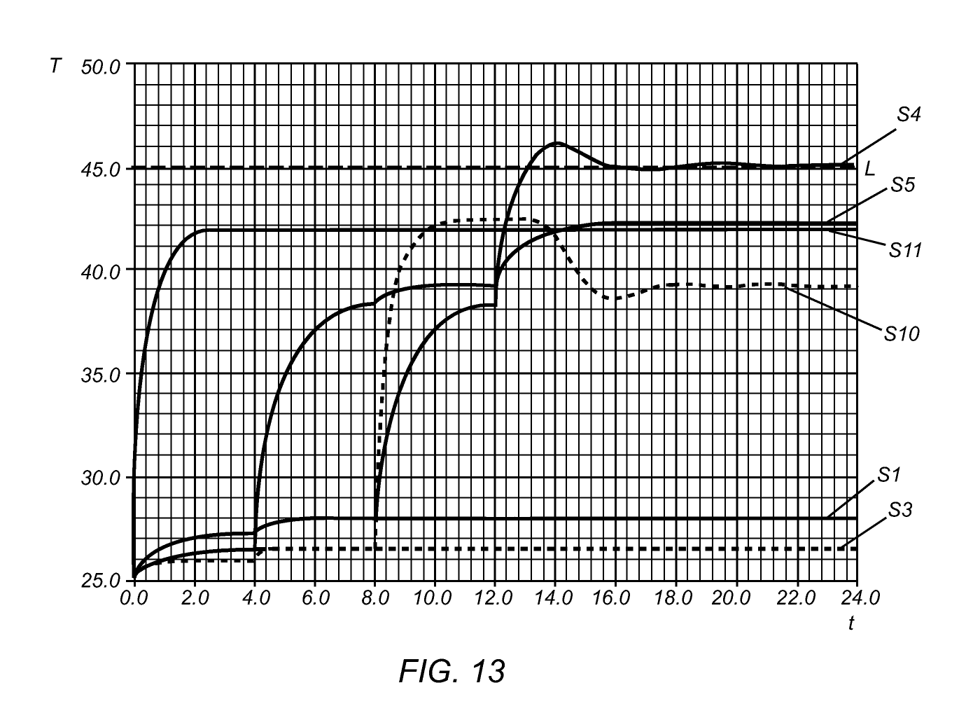

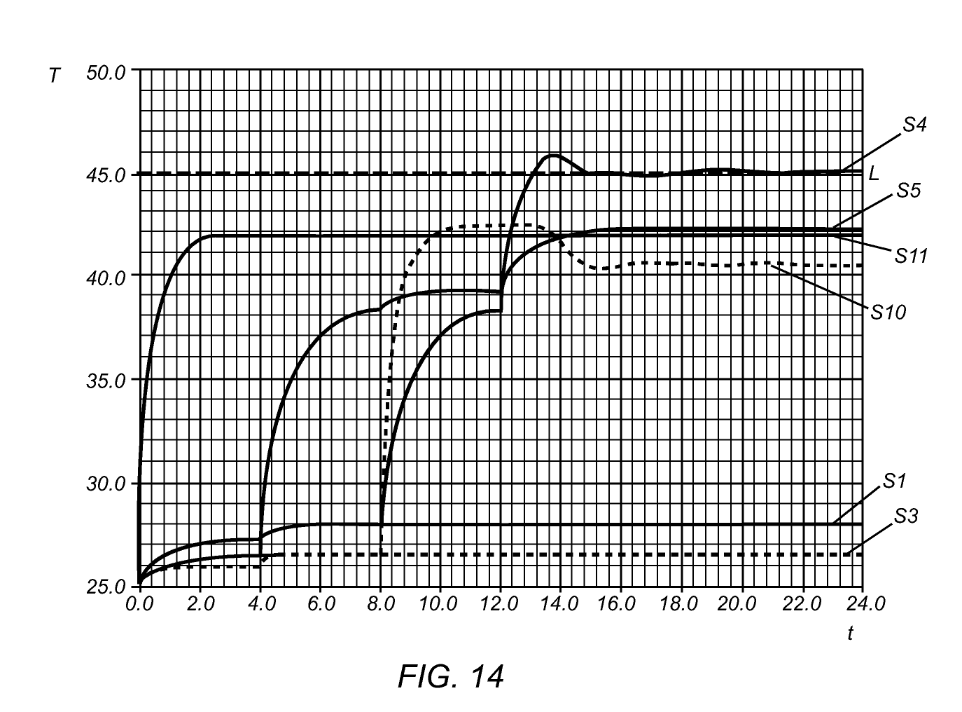

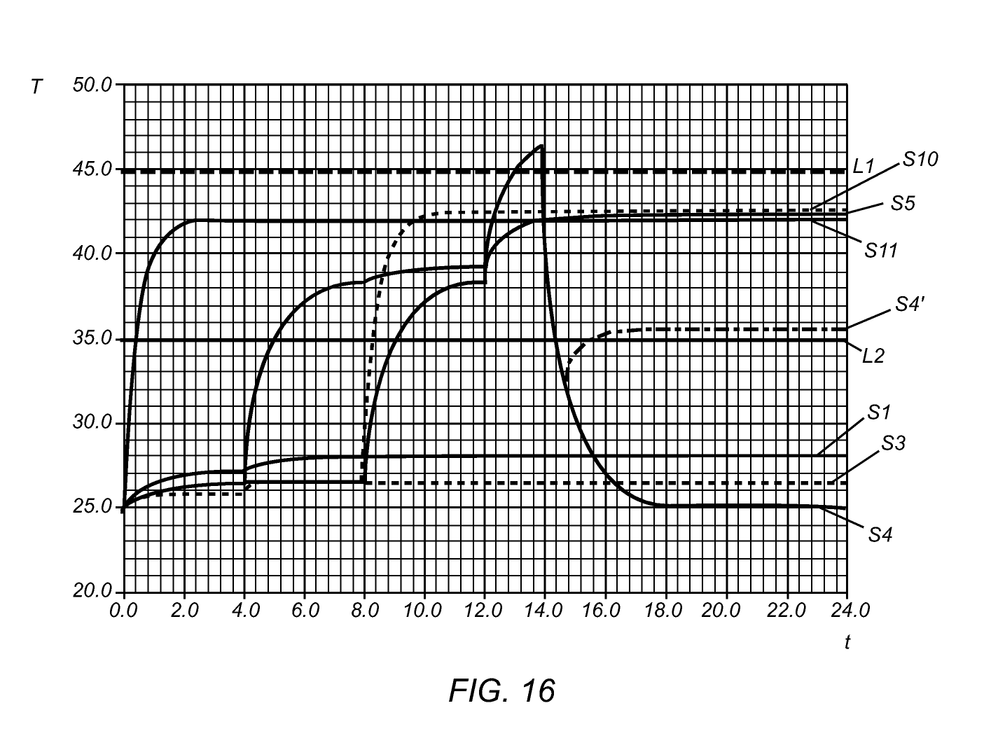

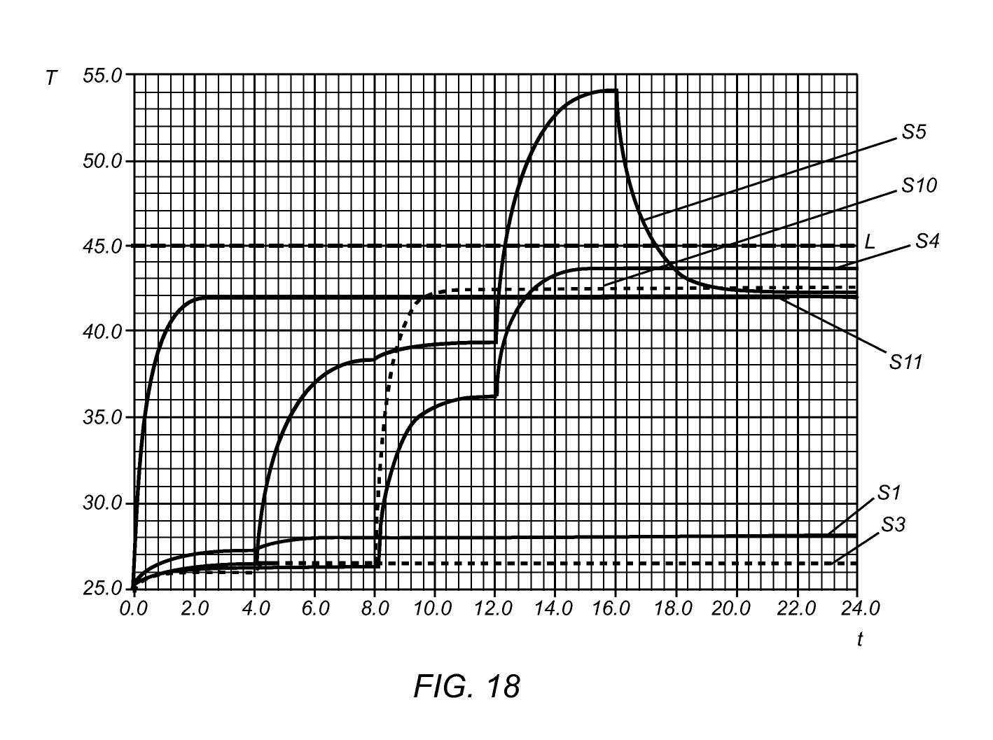

In case a lighting scene will cause a data switch to exceed the temperature limit L, the system may determine one or more mitigation actions as listed in table 2 below:

| UC | Description | Example | FIG. |
|---|---|---|---|
| UC1 | Diming | Switch is predicted to overheat and number of loads in | FIG. 12 |
| | | the scene is dimmed | FIG. 13 |
| | | | FIG. 14 |
| UC2 | Switching off data port | Switch is predicted to overheat and alternative data path | FIG. 18 |
| | | is found and/or number of loads is switched off. | |
| UC3 | Switching off entire | Switch is predicted to overheat and degradation of | FIG. 16 |
| | DfD | capabilities is accepted or notified | |
| UC4 | Scheduling | Switch is predicted to overheat and number of loads in | FIG. 18 |
| | | the scene is scheduled to be executed in the future. | |

Use case UC1 describes dimming as mitigation strategy in case of determining that a desired sequence of application scenes will lead to an overheated data switch in accordance with a first path configuration. The scenarios refer to the building plan of FIG. 8. Assuming the aforementioned power plan X of FIG. 10, the system could for example compute three alternative scenarios, such as for example:
Scenario A: dim the loads in room H to prevent data switch S4 from overheating. To keep an even light output of the lights in room H, the system dims the loads on 1 port of data switch S5 and 3 ports of data switch S4. The result is that the light output in room H is reduced to 72% of nominal. The temperature of switch S4 drops below the critical limit L as shown in FIG. 12.
Scenario B: dim the loads in room B to prevent that data switch S4 overheats. To keep an even light output of the lights in room B, the system will dim loads attached to data switch S4 and S10. The system dims the loads on 8 ports of data switch S10 and 4 ports of data switch S4. The result is that the light output in room H is reduced to 80% of nominal. The resulting temperature drops for switches S4 and S10 are shown in FIG. 13.
Scenario C: dim the loads in room B and room H to prevent data switches S4 from overheating. The system shall attempt to keep an even light output between the lights in room B and also room H. The system dims the loads on 7 ports of data switch S4 and 1 port on data switch S5 and 8 ports on data switch S10. The result is that the light output in rooms H and B is reduced to 88% of nominal. The resulting temperature drops for S4 and S10 are shown in FIG. 14. In this scenario the system dimmed rooms B and H to a common dimmed light output level, but that is not required and dimming levels for room B might differ from the level for room H in accordance with predetermined preferences which may be defined in the respective application scenes.

It shall be clear that many dimming scenarios are possible. The SDL system will chose the optimal scenario based on constraints which may be predetermined based on requirements of a specific application. As demonstrated in these three exemplary scenarios, the SDL system of the preferred embodiment can optimize the dimming strategy to achieve the overall highest possible light level over multiple rooms while keeping the respective end temperatures of the data switches involved in the application scenes below the upper temperature limit.

Use case UC2 describes switching off a data/power port and/or its attached load as a mitigation strategy. Assuming the aforementioned power plan X of FIG. 10, the SDL system could for example compute an alternative scenario, as for example:
Scenario A: the system switches off a load to prevent data switch S4 from overheating. The system proposes to select 1 load (e.g. a light bulb) and offers the following options to an admin or decides automatically in accordance with a predetermined preference between:
Option A1: Switch 1 light out in room B (choose any from L10, L14, L16, L20).
Option A2: Switch 1 light out in room H (choose any from L22 . . . L25).

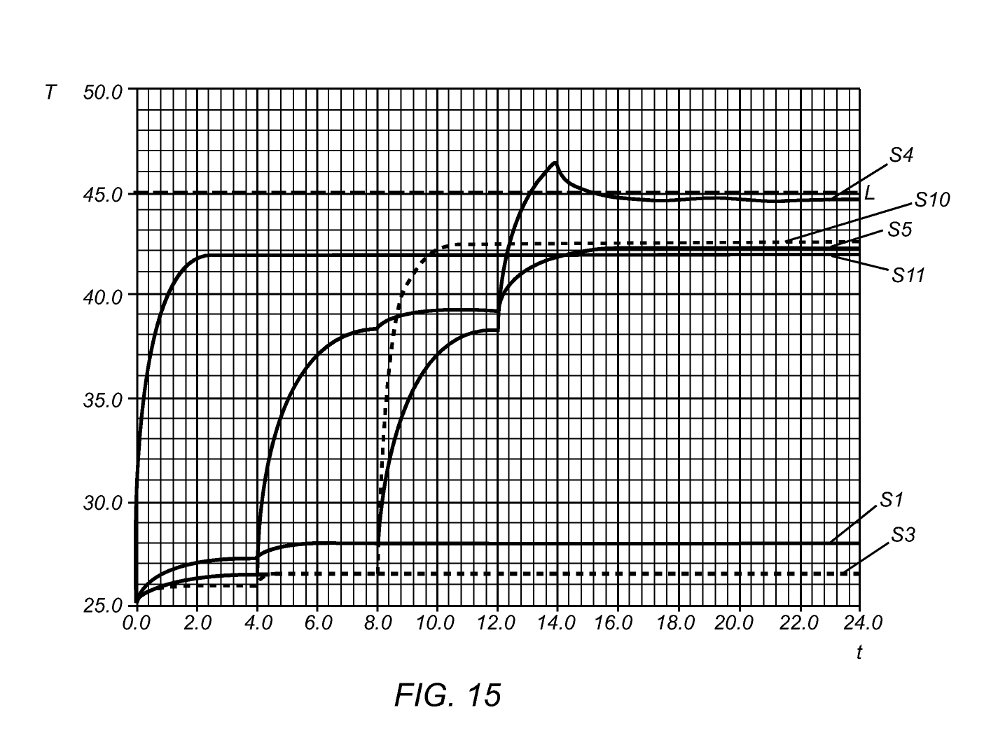

In this example several feasible options to switch off one load are computed and presented to the system. As an example, the system computes the respective feasibility, decides on basis of certain constraints that option A1 is a suitable alternative and chooses to have L10 from FIG. 8 switched off. The resulting temperature drop of switch S4 is shown in FIG. 15.

Use case UC3 describes switching off an entire data switch and its attached load(s) as a mitigation strategy. Assuming the aforementioned power plan X of FIG. 18, the system could for example compute alternative scenarios, as for example:
Scenario A: lights connected to data switch S4 in room B and H will be switched off.
Scenario B: lights connected to data switch S4 in room B and H will be switched off. After cooling down of data switch S4 below a lower temperature threshold L2 (e.g. 35° Celsius), there is a request from an application scene to switch on lights in room H.

The system computes the respective feasibility and decides on the basis of predetermined constraints that scenario B is a suitable alternative, and commands that the lights in room H from FIG. 8 are switched on after the lower temperature threshold L2 has been reached. The resulting temperature curves for both scenarios are shown in FIG. 16.

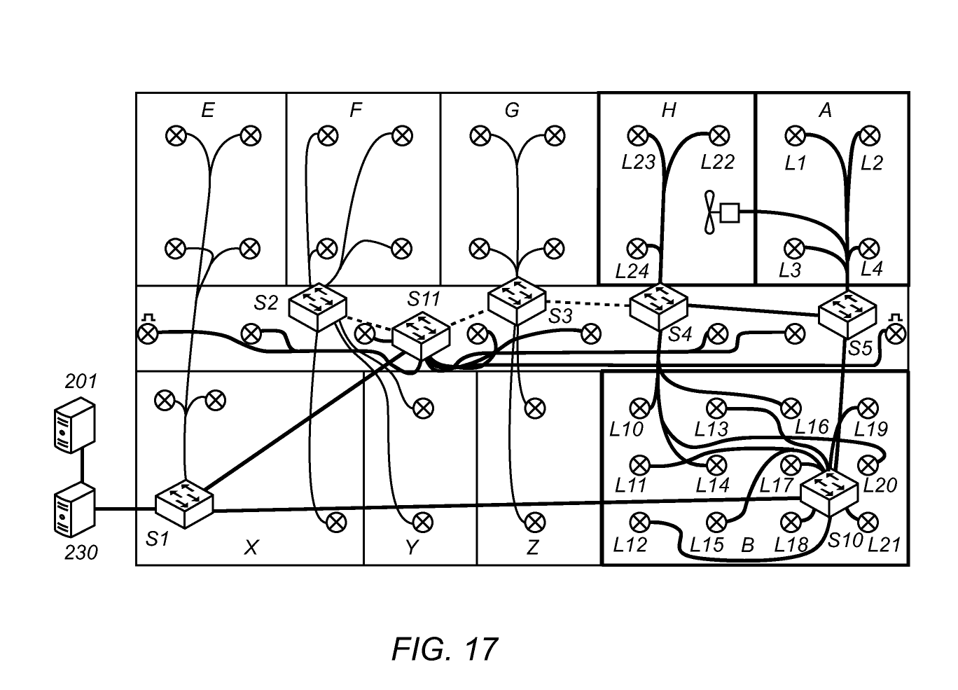

Use case UC4 describes scheduling as mitigation strategy. As an example, a heavy electrical load f1 (i.e. a fan) is connected to data switch S5, as shown in FIG. 17 which also powers L1-L4 in room A. As shown in FIG. 18, S5 will overheat shortly after the fan in room H has been switched on at t=12.

The underlying power plan differs slightly from power plan X. Power plan Y determines:
Lighting hallway 24/7 on: Switch S1 and S11
Lighting scene 1 is triggered: switch on lights L1-L4 in room A. The system requires S1, S10 and S5.
After certain time, lighting scene 2 is triggered: switch on lights L10, L14, L16 and L20 in room B. The system requires switch S4 for power supply.
Sometime later, lighting scene 3 is triggered: switch on lights L22 . . . L24 and fan f1 in room H. The system requires switches S4 and S5 for power supply.
Sometime later, lighting scene 4 is triggered which defines to switch off the lights in room A.

In use case UC4 an overload situation is present for a known period of time, namely the time in which lights L1-L4 and fan f1 are switched on. The system may thus choose scheduling as mitigation strategy and could for example compute an alternative scenario:

Scenario A: the system prevents overheating of data switch S5 by delaying the run time of the fan f1 until the lights in room A have been turned off, that is until application scene 4 is triggered.

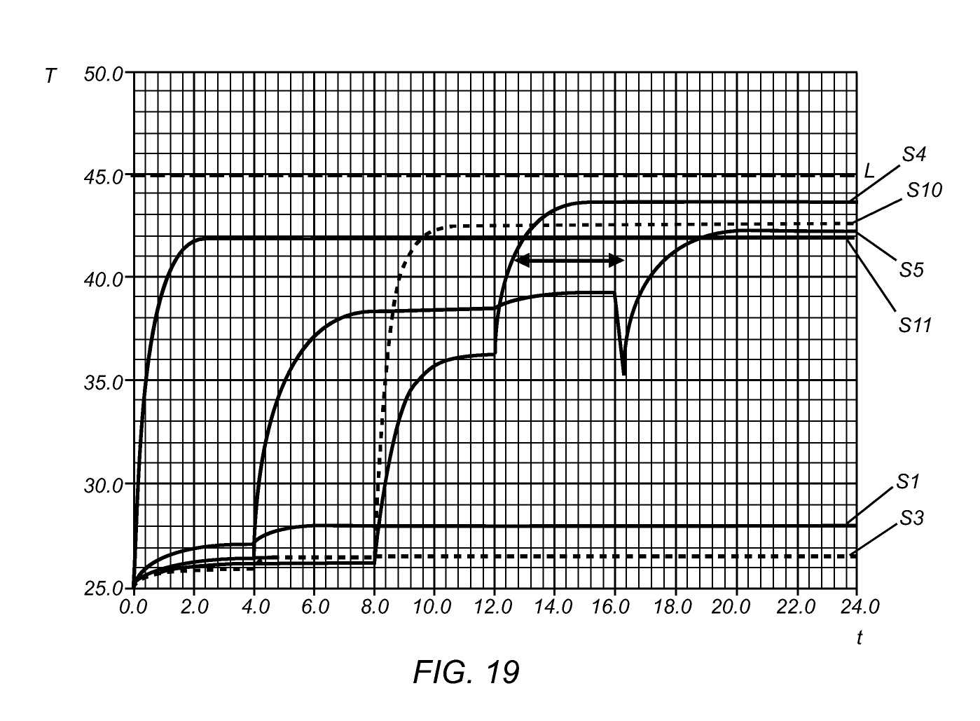

The system computes the respective feasibility and decides on basis of predetermined constraints that scenario A is a suitable alternative, and schedules a delay to have the heavy load run at a later time. The resulting temperature curve response of alternative scenario A is shown in FIG. 19.

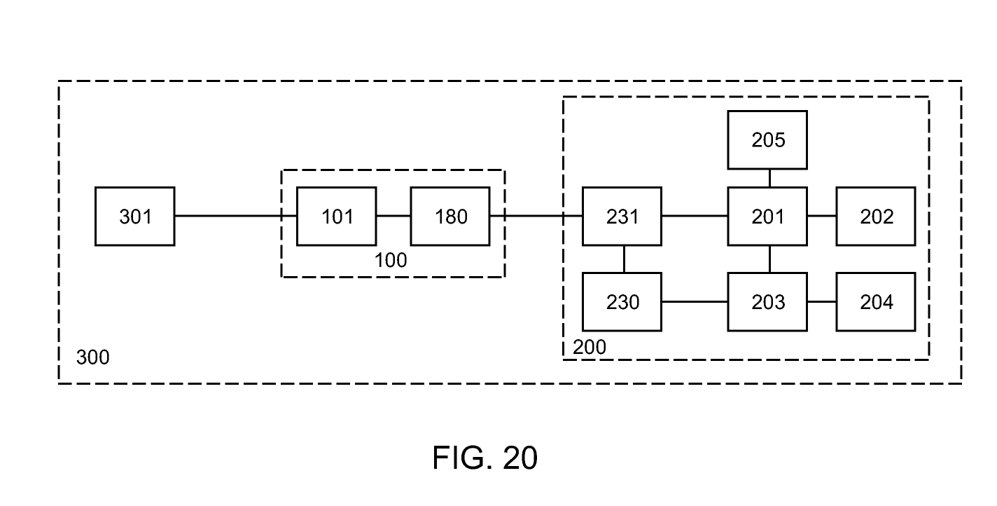

As shown in FIG. 20 the Software Defined Lighting (SDL) system 201 and the Software Defined Networking (SDN) system 231 may interact with one or more other Software Defined Application (SDA) systems 203 and network management systems 230 from other building works. An example is the integration of the building work “lighting” with the building works “solar shading” or “HVAC” or entirely different building works. In that case the SDL system 201 should not switch off certain intermediate forwarding devices, neither based on the lighting plan 202 nor on the load optimized application control plan 205, that could be required for the sensors and actuators in a application scene of another building work as comprised in application plan 204. The SDL system 201 may communicate with other SDA systems 203 to collaborate and align the operation schedules provided to the respective intermediate forwarding devices.

It shall be clear that many interfaces, present or newly defined can be used to integrate one Software Defined Control (SDC) system with another so as to aggregate and align the overall operation schedule to manage power of the required data paths. The two SDC systems do align each other to avoid fratricide where both systems would actively be switching off an intermediate forwarding device, causing the loss of required communication power supply paths and hence capabilities of the control network (i.e. control scenes).

The preferred embodiments can work with many types of intermediate forwarding devices. Preferred embodiment present examples with wired Ethernet switches, but an intermediate forwarding device can also be a router, a wireless access point or some other data passer.

Although the preferred embodiment works with wired Ethernet (SDN) switches, it shall be clear that the present invention also works with legacy Ethernet switches without an SDN protocol, and if so, the dynamic reprogramming of the data passing will not be available when an intermediate forwarding device is switched off due to overheating. In that case the system may still detect indirectly that certain capabilities (i.e. control scenes) of the control network are not available anymore, and report on the loss of certain capabilities.

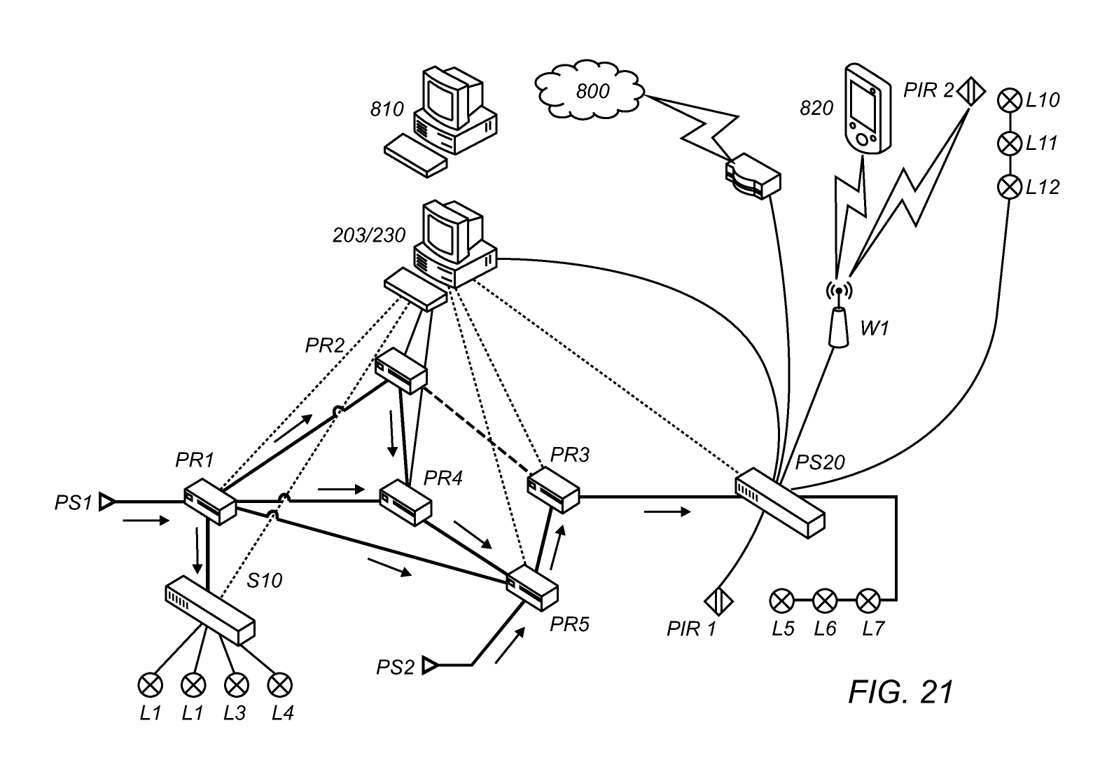

FIG. 21 shows a further preferred embodiment of the present invention in which power negotiations are not only performed between power supply equipment, e.g. a data switch, and power receiving equipment, e.g. a load, but also between different power supply equipment units, such as two data switches or two power routers. FIG. 21 shows a network topology with power routers PR1-PR4 which have higher power throughput capabilities than data switches S21 and S20. Power router PR1 and PR5 are connected to respective power sources PS1 and PS2. Data switches S21 and S20 are connected to respective power receiving units, such as lights L1-L12, a wireless communication unit W1 which may communicate with mobile device 820 or infrared presence detector PIR 1 and 2, or to the internet 800 via an internet router 801 such that data may also be received from remote, e.g. via a building app executable on a remote computer 810. The thermal behaviour of the power routers may be approximated by the same formula as given in FIG. 4. Standby power and power routing efficiency may differ from those of for instance data switches due to the different power routing capabilities. A typical power routing efficiency may be expected at 90%, a typical standby power may be 5 W. For the following considerations and examples the thermal resistance of the power routers PR2, PR4 and PR5 is considered to be the same. The thermal resistance of PR1 and PR 3 is supposed to be higher. According to a first application scene data switch S21 requires 400 W and data switch S20 requires 300 W. In an exemplary second application scene data switch S21 requires 400 W and S20 requires 600 W. For application scene 1 there is one power entry PS1. Scenario 1a may define that PR1 routes the required power of 400 W to S21 and 300 W via PR2 and PR3 to S20. Routing further 300 W from PR1 via PR 2 and PR3 to S20 as required by application scene 2 is assumed to overheat PR 2. The SDA system 203 may thus determine the thermal behaviour of the power routers for alternative scenarios, e.g.:

Scenario 1b: For application scene 2 route power from PR1 via PR5 and PR3 to S20, in that case PR5 shall overheat.

Scenario 1c: For application scene 2 route power from PR1 via PR4, PR5 and PR3 to S20, in that case PR4 and PR5 shall overheat.

Scenario 1d: For application scene 2 route power from PR1 partially via PR2 and PR3 to S20 and partially from PR1 via PR4, PR5 and PR3 to S20. In that case none of the power router is determined to overheat.

Scenario 1e: For application scene 2 route power from PR1 partially via PR2 and PR3 to S20 and partially from PR1 via PR5 and PR3 to S20. In that case none of the power router is determined to overheat.

The SDA system may present the alternatives to a user which may select an appropriate alternative or shall select an appropriate alternative scenario based on predetermined preferences such as, the overall power consumption. Wherein all power routers are active in scenario 1d, scenario 1e may be preferred since PR4 may not be used such that unduly power losses may be prevented.

In a further scenario the power supply may be balanced by using more than one power entry point. Instead of using only power provided by the power source PS1 connected to PR1, scenario 2a defines an additional power source PS2 connected to PR5. Scenario 2a may define to route 400 W to S21 via PR1 and 300 W from PR5 connected to PS2 via PR3 to S20 for the first application scene. Supplying further 300 W from PS2 requires PR5 to route a total 600 W via PR 3 to S20 for the second application scene: this is however supposed to overheat PR5. Again, the SDA system 203 may determine the thermal behaviour of the power routers for alternative scenarios, e.g.:

Scenario 2b: For application scene 2 route 400 W from PR1 to S21 and 300 W via PR2 and PR3 to S20 and 300 W from PR5 via PR3 to S20. In that case none of the power router is determined to overheat.

The SDA system thus also allows power negotiations between powersupplying equipment and thus allows a flexible thermal management of the power routers and the data switches by distributing the workload within the application control system while optimizing the balance in accordance with predetermined preferences.

The SDA system may compute the load optimized application control plan 205 once, at scheduled intervals or continuously. The system may build up a history and detect a delta over time, and extrapolate increasing power usage to identify the time estimate when potential problems could occur.

Procedures like determining temperature characteristics, extrapolating a maximum workload, receiving information about a plurality of communication path definitions and selecting a particular communication path definition, et cetera performed by one or several units or devices can be performed by any other number of units or devices. These procedures and/or the control of the management unit in accordance with the method for controlling the workload can be implemented as program code means of a computer program and/or as dedicated hardware.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

It shall be clear that a intermediate forwarding device can have electrical loads attached to it or not at all. An example of the latter is a wireless access point. The present invention works with all intermediate forwarding devices that can report data required for the best temperature advisor algorithm, and the system can compute end temperatures of the respective intermediate forwarding device.

It shall be clear that the present invention can connect electrical loads directly to a PoE data switch or use other embodiments.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. Management unit for controlling the workload of a plurality of intermediate forwarding devices capable of forwarding data or capable of forwarding data and power in an application control network, wherein each intermediate forwarding device comprises one or more ports, each connectable to a respective application control component and/or to a further intermediate forwarding device; the application control network comprises the plurality of intermediate forwarding devices and a plurality of application control components, wherein the plurality of intermediate forwarding devices are connected so as to forward data or forward data and power through its connected ports to the plurality of application control components, the management unit comprising:
a monitoring unit for determining an individual temperature characteristic of each intermediate forwarding device operated in a predetermined configuration;
a prediction unit for extrapolating a maximum workload for each intermediate forwarding device based on the temperature characteristics and the respective predetermined configuration;
a control unit for receiving information on a plurality of communication path configurations, the communication path configurations describing respective configurations of communication paths along the intermediate forwarding devices through the application control network to one or more application control components as required by an application scene determined in an application plan, wherein the application plan stipulates which sensors and actors are required to engage in an application scene, and
wherein the control unit is configured to select a particular communication path configuration that keeps the workload of each intermediate forwarding device below the maximum workload and to assist in applying the communication path configuration to the intermediate forwarding devices for the duration of the application scene.

2. Management unit according to claim 1, wherein at least one of the application control components is powered over Ethernet via a port of one of the intermediate forwarding devices.

3. Management unit according to claim 1, wherein the monitoring unit is configured to receive measurement and operation data samples from each intermediate forwarding device, wherein the measurement and operation data samples are taken over a predetermined time interval during commissioning and/or during normal operation of the application control network, and wherein the operation data comprises a number of ports in use and the measurement data comprises an end temperature and an accumulated power provided over all ports of the intermediate forwarding device.

4. Management unit according to claim 1, wherein, if the control unit determines that there is no suitable communication path configuration that keeps the respective workload of the plurality of intermediate forwarding devices below the respective maximum workloads, the control unit is configured to
(i) decrease a power output to one or more ports of a selected intermediate forwarding device, and/or
(ii) switch off one or more ports of a selected intermediate forwarding; and/or
(iii) switch off a selected intermediate forwarding device and/or
(iv) schedule a power output to a first group of one or more application control components associated with a selected intermediate forwarding device to start when a power output to a second group of one or more application control components associated with the selected intermediate forwarding device has finished wherein a first application scene associated with the first group of one or more application control components and a second application scene associated with the second group of one or more application control components overlap in time.

5. Management unit according to claim 1, wherein, if the control unit determines that there is no suitable communication path configuration that keeps the respective workloads of the plurality of intermediate forwarding devices below the respective maximum workloads, the control unit is configured to provide a warning notification.

6. Management unit according to claim 1, wherein the selected communication path configuration as selected by the control unit further provides a predetermined level of redundancy, a predetermined level of availability, a predetermined level of service of quality or a combination thereof.

7. Management unit according to claim 1, wherein the application scene defines a minimal power level for one or more application control components and wherein, if it is determined that there is no suitable communication path configuration that keeps the respective workloads of the plurality of intermediate forwarding devices below the respective maximum workloads, the control unit is configured to decrease a power output to one or more ports of a selected intermediate forwarding device attached to the one or more application control component down to the minimal power levels as set out in the application scene.

8. Method for controlling the workload of a plurality of intermediate forwarding devices capable of forwarding data or capable of forwarding data and power in an application control network, wherein each intermediate forwarding device comprises one or more ports each connectable to a respective application control component and/or a further intermediate forwarding device; the application control network comprises the plurality of intermediate forwarding devices and a plurality of application control components, wherein the plurality of intermediate forwarding devices are connected so as to forward data or forward data and power through its connected ports to the plurality of application control components, the method comprising:
determining an individual temperature characteristic of each intermediate forwarding device operated in a predefined configuration;
extrapolating a maximum workload for each intermediate forwarding device based on the temperature characteristics and the respective predefined configuration;
receiving information on a plurality of communication path configurations, the communication path configurations describing respective configurations of communication paths along the intermediate forwarding devices through the application control network to one or more application control components as required by an application scene determined in an application plan, wherein the application plan stipulates which sensors and actors are required to engage in an application scene, and
selecting a particular communication path configuration from the plurality of communication path configurations that keeps the workload of each intermediate forwarding device below the maximum workload and assisting in applying the communication path configuration to the intermediate forwarding devices for the duration of the application scene.

9. Method according to claim 8, wherein at least one of the application control components is powered over Ethernet via a port of one of the intermediate forwarding devices.

10. Method according to claim 8, wherein determining an individual temperature characteristic of each intermediate forwarding device comprises receiving measurement and operation data samples from each intermediate forwarding device, wherein the measurement and operation data samples are taken over a predetermined time interval during commissioning and/or during normal operation of the application control network, and wherein the operation data comprises a number of ports in use and the measurement data comprises an end temperature and an accumulated power provided over all ports of the intermediate forwarding device.

11. Method according to claim 8, wherein, if it is determined that there is no suitable communication path configuration that keeps the respective workload of the plurality of intermediate forwarding devices below the respective maximum workloads, the method comprises
(i) decreasing power output to one or more ports of overloaded selected intermediate forwarding device, and/or
(ii) switching off one or more ports of overloaded selected intermediate forwarding device; and/or
(iii) switching off a selected intermediate forwarding device; and/or
(iv) scheduling a power output to a first group of one or more application control components associated with a selected intermediate forwarding device to start when a power output to a second group of one or more application control components associated with the selected intermediate forwarding device has finished wherein a first application scene associated with the first group of one or more application control components and a second application scene associated with the second group of one or more application control components overlap in time.

12. Method according to claim 8, wherein, if it is determined that there is no suitable communication path configuration that keeps the respective workloads of the plurality of intermediate forwarding device below the respective maximum workloads, the method comprises providing a warning notification.

13. Method according to claim 8, wherein the selected particular communication path configuration further provides a predetermined level of redundancy, a predetermined level of availability, a predetermined level of service of quality or a combination thereof.

14. Method according to claim 8, wherein the application scene defines a minimal power level for one or more application control components and wherein, if it is determined that there is no suitable communication path configuration that keeps the respective workloads of the plurality of intermediate forwarding device below the respective maximum workloads, the method comprises decreasing a power output to one or more ports of a selected intermediate forwarding device attached to the one or more application control component down to the minimal power levels as set out in the application scene.

15. A computer program for controlling the workload of a plurality of intermediate forwarding devices capable of forwarding data or capable of forwarding data and power in an application control network, the computer program being executable in a processing unit, the computer program comprising program code means for causing the processing unit to carry out a method as defined in 8, when the computer program is executed in the processing unit.
